(19) United States
(12) Patent Application Publication
(10) Pub. No.: US 2008/0183576 A1
(43) Pub. Date: Jul. 31, 2008

(54) MOBILE SERVICE SYSTEM AND METHOD USING TWO-DIMENSIONAL COUPON CODE

(76) Inventors: Sang Hun KIM, Goyang-si (KR); Jung Il PARK, Seongnam-si (KR)

Correspondence Address: HESLIN ROTHENBERG FARLEY & MESITI PC, 5 COLUMBIA CIRCLE, ALBANY, NY, 12203, US

(21) Appl. No.: 11/782,076

(22) Filed: Jul. 24, 2007

(30) Foreign Application Priority Data
Jan. 30, 2007 (KR) 10-2007-0009426
May 29, 2007 (KR) 10-2007-0051903

(51) Int. Cl. G06Q 40/00

(52) U.S. Cl. 705/14

(57) ABSTRACT

A mobile service system using a two-dimensional coupon code and a method thereof are disclosed. A user captures the two-dimensional coupon code printed on a coupon and transmits the captured two-dimensional coupon code to a server, and captures a two-dimensional store code printed on a store medium and transmits the captured two-dimensional store code to a server, using his or her cellular phone. The server transmits data that allows the user to use a coupon to the user's cellular phone, and the data is inputted into a terminal of a store to use the coupon. Since a system stores and classifies a large number of coupons, the user does not need to keep and classify the coupons. In addition, if the user only possesses a cellular phone, the user can use a corresponding coupon at a store at any time.

### CROSS-REFERENCE TO RELATED APPLICATIONS

This application claims priority to Korean Patent Application No. 10-2007-0009426, filed Jan. 30, 2007, and to Korean Patent Application No. 10-2007-0051903, filed May 29, 2007, which applications are hereby incorporated herein by reference in their entirety.

### TECHNICAL FIELD

The present invention relates to a business model using a mobile terminal. A mobile terminal user transmits certain data to a server through a base station, and the server constructing a database provides utilizable contents to the mobile terminal according to a predetermined rule. Economic profits are realized by bi-directionally transmitting and receiving the data between the mobile terminal and the server.

### BACKGROUND OF THE INVENTION

Consumers desire to purchase merchandise at a further cheaper price, and sellers expect further more consumers to purchase their merchandise. Based on such nature of the consumers and sellers, discount coupons are much in vogue today. If a consumer presents a previously issued discount coupon when purchasing merchandise, the consumer can purchase the merchandise at a price discounted by a predetermined amount. However, too many coupons are issued in the market and circulated through online or offline. Therefore, it is difficult for the consumers to use a desired coupon among the flooded coupons at a desired place at a desired time. The present invention proposes a new business model using a mobile terminal in order to solve the problem. However, there is a limitation in current services that transmit and receive data, and use contents through the mobile terminal. Since the limitation should be overcome in order to accomplish the objects pursued by the present invention, mobile service environments will be observed first.

According to increase of the number of Internet users and related techniques, a variety of multimedia contents as well as simple text-oriented data is widely processed on the web. Recently, a large amount of data is exchanged and traded through the Internet, together with contents containing the data. From the viewpoint of information providers, a database storing the contents should be constructed, and an environment in which the consumers can easily access the database should be created. From the viewpoint of information consumers, the consumers need to know the location of desired contents and wish to conveniently and promptly obtain only desired information.

As schematically shown in FIG. 1, such requirements of the information providers and the information consumers are fulfilled through the Internet 2. The information consumers can connect to an information provider's website only by inputting a uniform resource locator (URL) or by clicking a link recording a URL through a computer terminal 1. The server 3 of the information provider can promptly transmit a large volume of data stored in the database 4 to the computer terminal 1 through the web. At this point, the information consumer previously knows the URL of the information provider or comes to know the location of the information provider through Internet search.

However, there is a problem in that such an Internet network 2 is lack of spontaneity and concurrency. There is an enormous amount of information in the Internet, as well as innumerable websites that provide the information. However, since contents desired by a user, such as a trailer of a specific movie, are generally very specific, it is inconvenient in that the user necessarily goes through a search process in order to obtain desired contents through the Internet.

That is, in order to obtain the specific information in the Internet, the user should connect to an Internet site where a large amount of other information is posted together with desired information. Further, there is a problem in that the user himself or herself should search for the specific information from the large-scale database. For example, in order to obtain existence of a discount coupon providing a certain economic profit, a coupon code thereof, and the method of using the discount coupon, the user should search for an Internet site that provides information thereon and spend a certain amount of time in searching a large number of movie databases of a corresponding site.

In addition, the Internet is very lack of mobility. Since the Internet needs the computer terminal 1 for network connection, there is a problem in that a moving user cannot easily use the Internet.

A cellular network is effective among the systems that can be used in transmitting data to a moving terminal. A mobile terminal can receive simple text or multimedia contents by way of a base station. Commercialization of the high speed downlink packet access (HSDPA), i.e., a 3.5 generation communication method, and spread of so-called HSDPA phones have brought construction of technical environments through which multimedia contents can be received. It is important in this network to construct a server provided with a database for storing contents to be transmitted to a mobile station and to determine how the mobile station specifies a transmission request for corresponding contents to the server. That is, the mobile station should be able to easily transfer location information of desired contents to the server side, and the server should previously construct a database for the corresponding contents. However, it is very difficult for the mobile station to easily obtain location information of contents.

In addition, since a mobile terminal is not provided with a keyboard or a mouse as is a notebook computer or a personal computer (PC) and has a small display, the user interface is poor. Accordingly, it is not easy to search for information or to construct and transmit a request signal. Therefore, means or a method of simplifying the input process becomes an essential element in the technical field of receiving and reproducing contents using a mobile terminal or in a business model based thereupon.

That is, in a method of using contents through a cellular network, although a user can advantageously use the contents while moving, there is a critical problem in that a consumer cannot easily access to the contents. Accordingly, the consumer cannot easily grasp where the contents are, and although the consumer knows the location of the contents, there is a limit in using the contents in a speedy and convenient manner. It is since that the consumer does not know the existence of desired contents and should search for the contents although the consumer knows the existence of the contents, and a user interface for performing the search is poor.

Accordingly, it is conventionally not easy to obtain a ‘desired’ discount coupon or information on the discount coupon, and there is a problem in that it is not easy to know where to use an acquired discount coupon. Further, if the user by himself or herself does not carry the discount coupon when using the discount coupon, it is not easy to immediately use the discount coupon at a desired place at a desired time. Although the Internet or a mobile terminal is used to solve the problems, if they are used in a conventional method, there is a limitation due to mobility, immediacy, and a poor user interface.

### SUMMARY OF THE INVENTION

Therefore, the present invention has been made in view of the above problems, and it is a first object of the present invention to provide a system and method, which provides practical economic profits and convenience to consumers by allowing further more discount coupons to be circulated and used, and provide further more sales opportunities to sellers.

It is a second object of the present invention to provide a system and method, in which in relation to discount coupons, a subscriber is allowed to obtain a desired discount coupon whenever and wherever through a subscriber's mobile terminal from a location where the coupon is provided, and detailed information on the corresponding discount coupon is immediately transmitted to the mobile terminal user if needed. Since the consumer can immediately obtain the discount coupon from a location where the discount coupon is provided (regardless of online or offline), a separate troublesome search process is not needed.

It is a third object of the present invention to provide an environment where coupons can be easily used by directly associating coupons with stores where the coupons can be used.

On the other hand, the other objects unspecified in the present invention will be additionally considered within the range that can be easily inferred from the following detailed descriptions and effects thereof.

To accomplish the above objects, according to a first aspect of the present invention, there is provided a mobile service system using a two-dimensional coupon code, comprising a coupon code and a store code printed in the form of a two-dimensional code pattern, N coupons (N is an integer larger than one) having a two-dimensional code pattern area where the coupon code is printed, a store medium existing at a predetermined location within a store and having a two-dimensional code pattern area where the store code is printed, a mobile terminal for photographing and reading the coupon code printed on the coupon and the store code printed on the store medium using a digital camera, and transmitting coupon code data and store code data respectively to a server, the server for transmitting service data to the mobile terminal through a mobile communication network and providing information needed for using the coupon, and a store terminal for recording a coupon being used and transmitting coupon use data to the server.

In a certain embodiment, the service data is preferably coupon contents for providing detailed information on the coupon.

In addition, in another embodiment, transmission of the service data is preferably text transmission of advertisement contents or moving image streaming of advertisement contents to the mobile terminal.

In addition, in another embodiment, the service data is identification marking data needed for using the coupon code, which is preferably contents that identify a coupon code corresponding to the store code.

In addition, a code reader unit for reading the coupon code and the store code is embedded within the mobile terminal, and memory of the code reader unit preferably stores image data of the two-dimensional code photographed by the digital camera and a two-dimensional code reader program for reading the image data.

In addition, the mobile terminal is preferably a cellular phone embedded with the digital camera.

In addition, the server may include a database for storing users of the mobile terminals classified by an individual member, a database for storing store codes, and a database for storing coupon codes.

In addition, according to a second aspect of the present invention, there is provided a mobile service method using a two-dimensional coupon code, comprising the steps of: printing the coupon code and a store code, respectively, on a coupon and a store medium in the form of a two-dimensional code pattern, capturing the two-dimensional code pattern of the coupon code printed on the coupon using a digital camera of a mobile terminal of a mobile station subscriber, and automatically or manually transmitting coupon code data to a server according to a predetermined rule, allowing the server to store the coupon code data in a personal database, capturing the two-dimensional code pattern of the store code printed on the store medium using the digital camera of the mobile terminal of the mobile station subscriber, and automatically or manually transmitting store code data to the server according to a predetermined rule, allowing the server to search the personal database and compare data in order to determine whether coupon data corresponding to the store code data exists, allowing the server to transmit identification contents needed for using the coupon to the mobile terminal if corresponding coupon data exists, allowing a store terminal to read the identification contents as a step of using the coupon, and allowing the store terminal to record the used coupon and transmit coupon use data to the server.

In addition, the mobile service method preferably further comprises the step of allowing the server to transmit coupon contents or advertisement contents corresponding to the coupon code to the mobile terminal.

In addition, the identification contents are preferably a one-dimensional bar code image file.

In addition, the mobile terminal is preferably a cellular phone embedded with the digital camera.

In addition, in the step of using the coupon, the coupon is preferably used in a method of discounting a price based on a predetermined percentage or in a method of exempting payment by total monetary value of points.

In addition, according to a third aspect of the present invention, there is provided a mobile service method using a two-dimensional coupon code, comprising the steps of: printing the coupon code on a coupon in the form of a two-dimensional code pattern, capturing the two-dimensional code pattern of the coupon code printed on the coupon using a digital camera of a mobile terminal of a mobile station subscriber, and automatically or manually transmitting coupon code data to a server according to a predetermined rule, allowing the server to store the coupon code data in a personal database, and allowing the server to transmit coupon contents or advertisement contents corresponding to the coupon code to the mobile terminal.

Further, additional features and advantages are realized through the techniques of the present invention. Other embodiments and aspects of the invention are described in detail herein and are considered a part of the claimed invention.

### BRIEF DESCRIPTION OF THE DRAWINGS

The above and other objects, features and advantages of the present invention will be apparent from the following detailed descriptions of the preferred embodiments of the invention in conjunction with the accompanying drawings, in which:

FIG. 1 is a view schematically showing a conventional contents transmission system using the Internet;

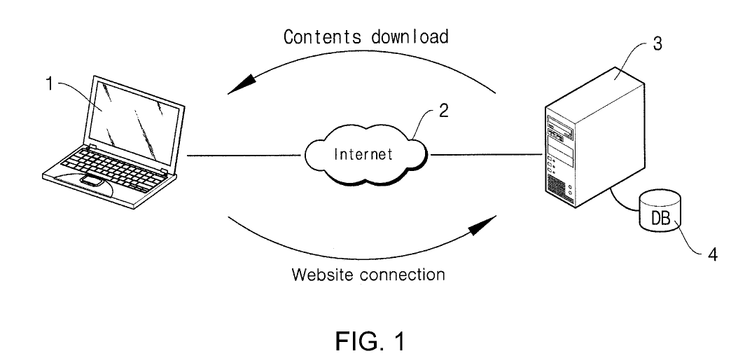

FIG. 2 is a view schematically showing an example of the configuration of the entire system according to the present invention;

FIG. 3 is a view showing the concept of the relation between a coupon and a mobile terminal according to the present invention;

FIG. 4 is a view showing an example of a two-dimensional code;

FIG. 5 is a view schematically showing an example of the internal configuration of a code reader unit of the mobile terminal used in the present invention;

FIG. 6 is a view schematically showing an example of the configuration of the entire process according to the present invention;

FIG. 7 is a view showing an embodiment of a first region among the embodiments of the present invention;

FIG. 8 is a view showing an embodiment of a second region among the embodiments of the present invention; and

FIG. 9 is a view showing an embodiment of a third region among the embodiments of the present invention.

### BEST MODE FOR CARRYING OUT THE INVENTION

Embodiments of the present invention are hereafter described in detail, with reference to the accompanying drawings.

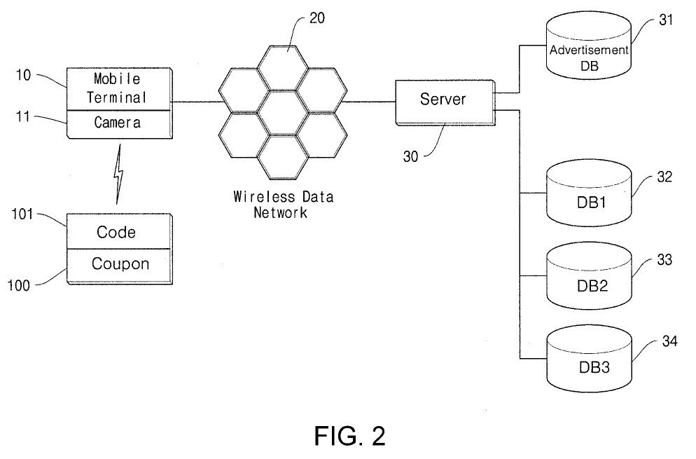

FIG. 2 schematically shows an example of a configuration of a system according to the present invention. A two-dimensional code 101 pattern is printed on a coupon 100. The two-dimensional code 101 of the coupon is photographed through a digital camera 11 provided to a mobile terminal 10. The photographed two-dimensional code is read, and the read code information is transmitted to a server through a base station (included in a mobile communication network 20). The server 30 has a plurality of databases. DB1 32 is a coupon database for storing data on coupons, DB2 33 is a personal database for storing code information of transmitted coupons that is classified individually, and DB3 34 is a seller database for storing the coupons classified by the seller who accepts the coupons. On the other hand, an advertisement DB 31 means a database for storing advertisement information that is to be transmitted to subscribers, which can be utilized or not according to service applications. Other than these databases, a log database, a member database, or the like needed for system configuration of the server 30 is not shown in the figure.

Since the two-dimensional code should be photographed using the digital camera embedded in the mobile terminal 10 in the system of the present invention, a user is close to a coupon. Generally, if a user is close to a coupon, the user desires to immediately obtain direct information on the coupon or to do a kind of a ‘keeping behavior’ for using the coupon at a later time. In the present invention, such a desire can be fulfilled only by photographing the two-dimensional code printed on the coupon using the cellular phone that the user himself or herself has. For this purpose, DB1, DB2, and DB3 provided in the server side can be all together or selectively utilized.

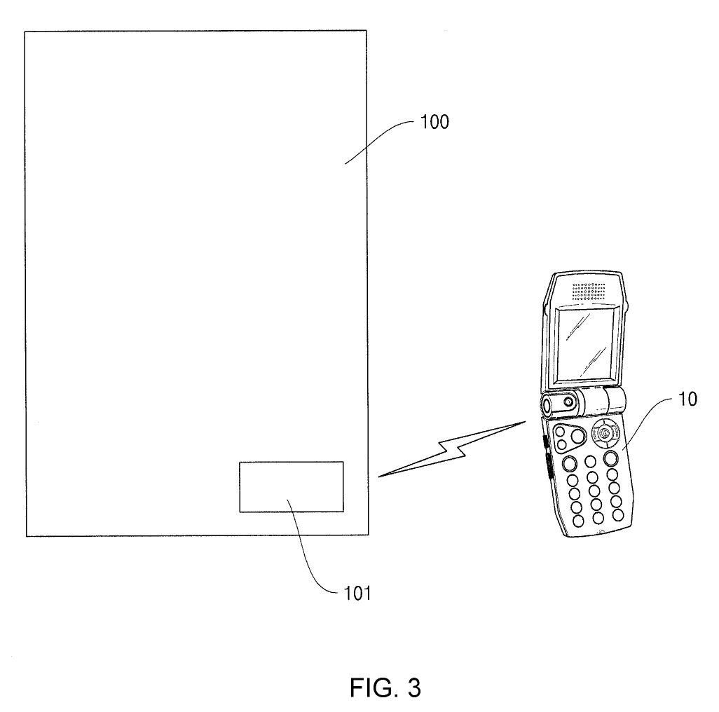

FIG. 3 schematically shows the relation between the coupon 100 and the mobile terminal 10. It means the relation between the coupon 10 and a user who uses the coupon. The user is very close to the coupon. In understanding the spirits of the present invention, it is very important to understand the relation between the coupon and the user. On the other hand, the coupon 100 is something that is circulated offline, which can be made of a material such as a paper, a plastic or the like or can be something displayed online on a monitor screen of a computer. It should be noted that all the coupons 100 used in the present invention have a two-dimensional code 101.

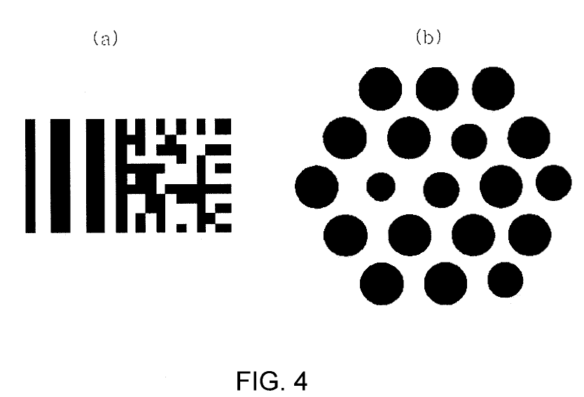

FIGS. 4(a) and 4(b) show examples of the two-dimensional code. A two-dimensional code pattern of the present invention stores a pre-assigned coupon code, and it is also noted that the two-dimensional code pattern can have a variety of forms and types.

The coupon has at least one or more two-dimensional code pattern areas where such a two-dimensional code pattern is printed. The two-dimensional code pattern area is created by directly printing the two-dimensional code pattern on the coupon. However, the two-dimensional code pattern area is also formed by attaching a printed two-dimensional code pattern to a specific position of the coupon. In the case of a coupon provided online, a two-dimensional code will be displayed as an image file at a certain position of a webpage. In the claims of the present invention, all of such methods are expressed as ‘print’.

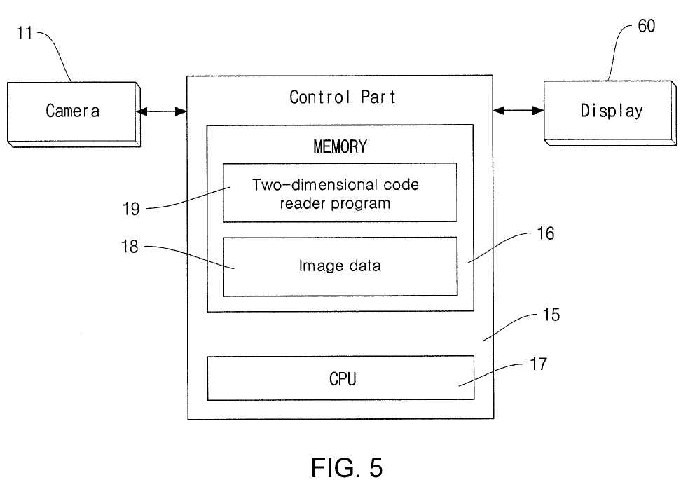

Hereinafter, how the mobile terminal reads such a two-dimensional code pattern will be described. FIG. 5 shows a code reader unit 15 including memory 16 and a central processing unit (CPU) 17, a display 60 for displaying image information (a two-dimensional code), and a digital camera 11 for capturing the image information. That is, FIG. 5 shows the code reader unit 15 of the internal configuration of the cellular phone embedded with a digital camera. The memory 16 of the code reader unit 15 memorizes image data 18 inputted through the digital camera 11 and a two-dimensional code reader program 19 for performing a function of reading the two-dimensional code. The CPU 17 controls the two-dimensional code reader program 19 and performs two-dimensional code image processing according to the two-dimensional code reader program 19. The two-dimensional code reader program 19 includes a module for reading image data of a captured two-dimensional code pattern and a module for recognizing the coupon code of corresponding image data.

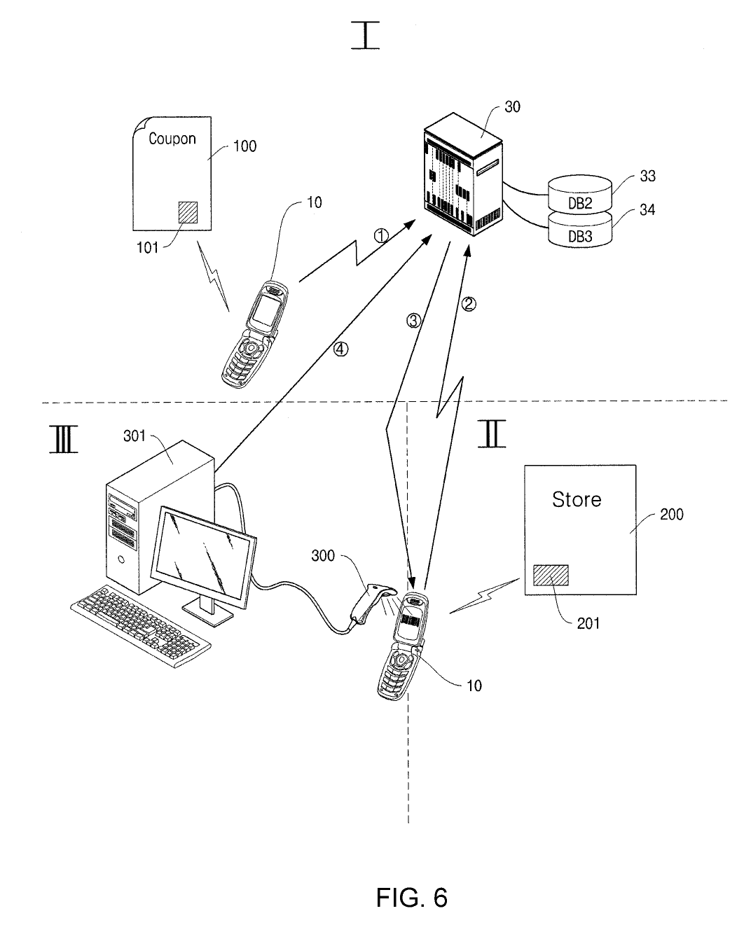

FIG. 6 schematically shows an example of the entire system of a business model according to the present invention. The system can be largely divided into three regions. A first region I is a region where a coupon code unique to a coupon is captured and transmitted to the server using the mobile terminal 10. A second region II is a region where a store code unique to a store is captured and transmitted to the server using the same mobile terminal 10. A third region III is a region where the server reads the data value transmitted to the same mobile terminal 10 and utilizes the coupon, using a reader provided in the store. First, the entire system is schematically described referring to FIG. 6, and then the process of each region will be described in further detail.

A coupon code 101 is printed on a coupon 100 in the form of a two-dimensional code. The coupon code 101 is unique to each coupon. If a user of the mobile terminal 10 captures the coupon code 101 using the digital camera of the mobile terminal, coupon code data is automatically or manually transmitted to the server 30 following a predetermined procedure, and the server 30 stores the corresponding coupon code data into the personal DB2 33. That is, the user obtains the same effect as personally possessing a corresponding coupon code only by photographing the coupon code using his or her cellular phone. In addition, by repeatedly performing the coupon capture action, the user can store a large number of coupons in the server side.

Next, a manner of using the coupon is described. The user visits a store to purchase merchandise. A unique coupon code 201 printed in the form of a two-dimensional code (which is defined as a “store code”) is also prepared in the store, printed on a store medium 200, and provided to the customer. The user of the mobile terminal 10, i.e., the customer, automatically or manually transmits store code data to the server 30 by capturing the store code using the digital camera of the mobile terminal. The server confirms whether data corresponding to the store code data exists in DB3 34 and searches DB2 33 in order to confirm whether the user has a coupon code corresponding to the store code data. If a corresponding coupon code exists, the server 30 transmits data for identifying the coupon code to the mobile terminal 10. The identification data is displayed on the screen of the mobile terminal 10, which can be a one-dimensional bar code image file. If the user shows the one-dimensional bar code image file received from the server 30 when purchasing merchandise and paying for the merchandise, the clerk reads the image file using the reader 300 in the store, thereby using the coupon. The reader 300 can be understood as a general-purpose reader that is generally used at a super store to receive payment for merchandise. If the coupon is used, the terminal 301 in the store transmits an event notifying the use of a corresponding coupon to the server 30, and the server 30 updates DB2 33. Such a schematic system of the present invention will be described below in further detail.

### EMBODIMENT OF THE FIRST REGION

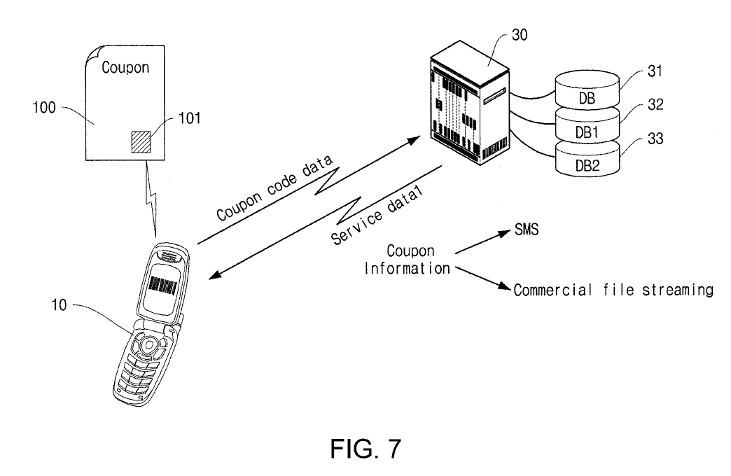

FIG. 7 shows the first region of the system according to an embodiment of present invention. A user of the mobile terminal 10 is a mobile station subscriber of a mobile communication company. In addition, the user needs to be previously registered as a member of the system in order to use the services provided by the server 30. If the mobile terminal 10 captures the coupon code 101 of the coupon 100 using the digital camera, the two-dimensional code reader program 19 extracts coupon code data by reading the image data of the captured two-dimensional code pattern. Then, the mobile terminal automatically or manually transmits the coupon code data to the server 30. If the captured image data is read as a coupon code 101 of a two-dimensional code, the mobile terminal can automatically transmit the coupon code data to the server by an application program stored in the memory. Alternatively, the mobile terminal inquires the user through the display of the mobile terminal whether to transmit the coupon code data to the server, and the mobile terminal can transmit the coupon code data to the server if the user inputs “Yes”. The server 30 stores the received corresponding coupon code data into DB2 33.

DB2 33 classifies the coupon code data by the individual member and has a table for effectively storing and managing the coupon code data. The table can include all or some of a serial number for identification, issue number of the coupon, issuer, discount rate, issue date, valid date, conditions on using the coupon, information on the product, and the like. The user obtains the same effect as personally possessing a corresponding coupon code only by photographing the coupon code using his or her cellular phone. In addition, by repeatedly performing the coupon capture action, the user can store a large number of coupons in DB2 33 in the server side.

In a certain embodiment, the server 30 extracts coupon contents, corresponding to the coupon code received from the mobile terminal 10, from the database 32 and transmits the extracted coupon contents to the mobile terminal 10. The coupon contents inform of information on the corresponding coupon. If the coupon contents stored in the database 32 are a moving image file, the corresponding coupon contents are streamed in real-time through the display of the mobile terminal 10 that has requested transmission of the contents. If the coupon contents stored in the database 32 are text, the coupon contents will be displayed on the screen of the mobile terminal 10 in a short message service (SMS) method. In another embodiment, the server 30 extracts advertisement contents from DB 31 and transmits the advertisement contents to the mobile terminal 10. The advertisement contents can be an advertisement for a certain product for which the coupon can be used.

In order to transmit such contents, the server operator first creates contents containing information related to coupons. The contents are a media file and should be encoded into a streaming file by an encoder in order to stream the media file to the mobile terminal. Particularly, the media file should be converted into a streaming file that conforms to the mobile standard and has an appropriate bit rate and size, codec, file format, and the like so that the media file can be streamed in a mobile environment. The encoded streaming file is stored in a media folder of a streaming server, and a link for corresponding media is created so that the mobile terminal can connect to the streaming server and receive a streaming service. If a streaming request for corresponding contents is received from the mobile terminal, the streaming server streams the corresponding contents to the mobile terminal through a transmission network, such as a cellular network. The contents can be text in another embodiment, and in this case, a separate SMS server should be provided. At this point, transmission of the contents is performed in the form of an SMS, not a streaming.

Accordingly, ‘service data 1’ shown in FIG. 7 means the coupon contents and/or advertisement contents.

### EMBODIMENT OF THE SECOND REGION

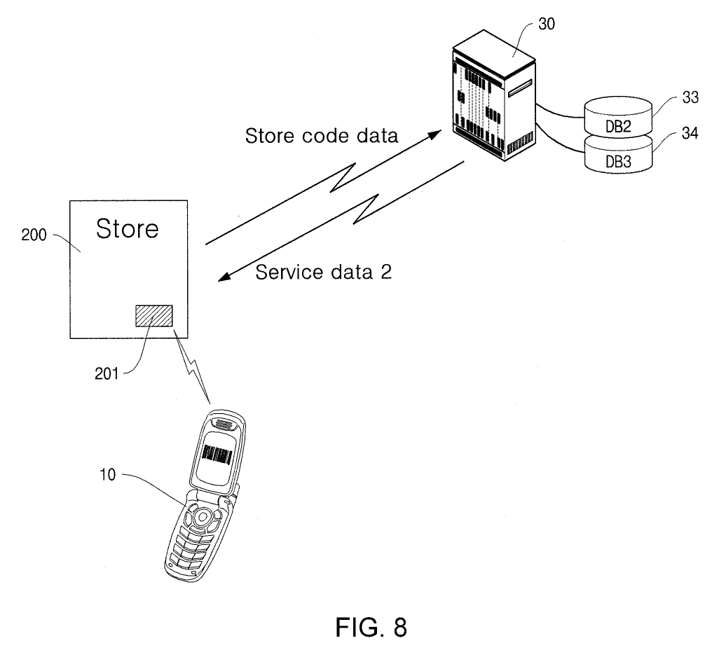

FIG. 8 schematically shows the process that occurs when the customer's mobile terminal 10 captures the store code 201 printed (or displayed) on the store medium 200 in a store of a seller. There are various kinds of store medium 200, such as a paper sheet, plastic sheet, wall, display of electronic merchandise, and the like that are prepared in the store.

If the mobile terminal 10 captures the store code 201 using the digital camera, the two-dimensional code reader program of the mobile terminal reads the image data of the captured two-dimensional code pattern and extracts coupon code data. Then, the mobile terminal 10 automatically or manually transmits the coupon code data to the server. This procedure is the same as the process of capturing a coupon code in the first region and transmitting coupon code data to the server. For this purpose, a database that previously classifies each store to be unique should be constructed in advance. The server confirms whether data corresponding to the store code data exists in DB3 34 and searches DB2 33 in order to confirm whether the user has a coupon code corresponding to the store code data.

The subscriber wonders, “Do I have any coupon that can be used in this store among the coupons that I have?” The present system is provided with DB2 33 and DB3 34 to automatically answer such a subscriber's question and has a comparison table for effectively corresponding data of DB2 33 to data of DB3 34. In addition, the data related to the coupon code and the data related to the store code stored in the database preferably have a common identifier to effectively correspond the coupon code to the store code.

### EMBODIMENT OF THE THIRD REGION

If a corresponding coupon code exists, the server 30 transmits data for identifying the coupon code to the mobile terminal 10, and the data is displayed on the screen of the mobile terminal 10. In FIG. 8, the identification marking data is expressed as ‘service data 2’. The identification marking data functions as a conventional coupon. The ‘service data 2’ can be any one of text, a one-dimensional bar code image file, and a two-dimensional bar code image file. In the case of text, it is inconvenient in that a clerk of the store should input the text comprising a combination of characters and numerals into a store terminal. In the case of a two-dimensional bar code image file, each store is required to be provided with a separate bar code reader. However, since a bar code reader used in a store these days is generally a one-dimensional bar code reader, if the ‘service data 2’ is a one-dimensional bar code image file, the bar code reader can be further usefully utilized. That is, in the same manner as a clerk of a store reads the bar code of merchandise to calculate the price of the purchased merchandise when the clerk charges the price of the merchandise, the coupon can be conveniently used by approaching the one-dimensional bar code displayed on the screen of the mobile terminal to the bar code reader of the store.

Using a coupon generally means a discount of a price based on a predetermined percentage. However, it is possible to purchase merchandise with the commercial monetary value that the coupon itself has. For example, if coupon A is a 20% discount coupon that can used for children's clothes B, the price can be discounted by 20% when purchasing children's clothes B. In addition, if coupon C is a “US$10” coupon, the user can submit coupon C displayed on the screen of the mobile terminal in stead of paying for with a US$10 bill. If the user stores a large number of coupons in the user's database, points can be given to each coupon, and if the points exceed a predetermined point value, the points can be used like money as well (a method of exempting payment by total monetary value of points). For this purpose, a certain rule agreed among coupon issuers, server operator, and sellers, and implemented in software needs to be created and stored.

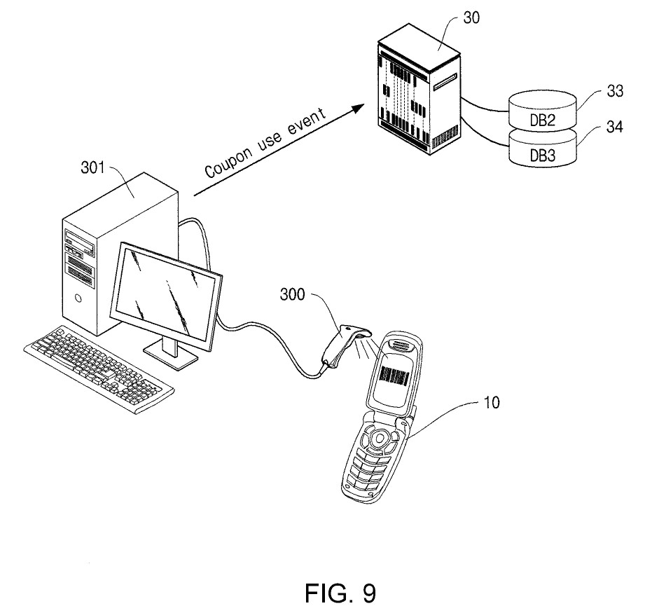

Referring to FIG. 9, the coupon is used by reading ‘service data 2’ through the reader 300 in the store. The terminal 301 of the store transmits an event notifying that a corresponding coupon has been used to the server 30, and the server 30 updates DB2 33. The server deletes corresponding data from the personal DB2 33 so that the used coupon cannot be used again. The server 30 records the fact that the corresponding coupon has been used.

The mobile service using the two-dimensional coupon code of the present invention can be diversely and extensively used for accessories, presents, computers, apparel, toys, home fashions, shoes, books, sporting goods, office supplies, magazines, pets, traveling gears, cellular phones, tickets, traveling vouchers, flowers, bags, golf gears, beauty products, health products, infant products, cosmetics, electronics, foodstuffs, and the like.

According to the present invention described above, since an environment in which further more discount coupons can be circulated and used is established, it is advantageous in that further larger economic profits are provided to consumers and further more consumers are connected to sellers.

According to the present invention, it is advantageous in that coupons are further conveniently kept and used. A user does not need to carry or keep a large number of discount coupons by himself or herself, and coupons can be stored only by photographing two-dimensional codes of corresponding coupons. In addition, valid coupons can be automatically searched only by photographing the two-dimensional codes of a store, and the searched coupons can be used on the spot.

In addition, since traffic for using wireless packets is increased in the present invention, it will significantly contribute to create profits of mobile communication companies. It is a business model that functions as useful means for a variety of marketing and advertisement activities, thereby creating a large profit.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A mobile service system using a two-dimensional coupon code, comprising:
a coupon code and a store code printed in the form of a two-dimensional code pattern;
N coupons (N is an integer larger than one) having a two-dimensional code pattern area where the coupon code is printed;
a store medium existing at a predetermined location within a store and having a two-dimensional code pattern area where the store code is printed;
a mobile terminal for photographing and reading the coupon code printed on the coupon and the store code printed on the store medium using a digital camera, and transmitting coupon code data and store code data, respectively, to a server;
the server for transmitting service data to the mobile terminal through a mobile communication network and providing information needed for using the coupon; and
a store terminal for recording a coupon being used and transmitting coupon use data to the server.

2. The system according to claim 1, wherein the service data is coupon contents for providing detailed information on the coupon.

3. The system according to claim 1, wherein transmission of the service data is text transmission of advertisement contents or moving image streaming of advertisement contents to the mobile terminal.

4. The system according to claim 1, wherein the service data is identification marking data needed for using the coupon code, which is contents that identify a coupon code corresponding to the store code.

5. The system according to claim 1, wherein a code reader unit for reading the coupon code and the store code is embedded within the mobile terminal, and memory of the code reader unit stores image data of the two-dimensional code photographed by the digital camera and a two-dimensional code reader program for reading the image data.

6. The system according to claim 1, wherein the mobile terminal is a cellular phone embedded with the digital camera.

7. The system according to claim 1, wherein the server includes a database for storing users of the mobile terminals classified by an individual member, a database for storing store codes, and a database for storing coupon codes.

8. A mobile service method using a two-dimensional coupon code, comprising:
printing the coupon code and a store code, respectively, on a coupon and a store medium in the form of a two-dimensional code pattern;
capturing the two-dimensional code pattern of the coupon code printed on the coupon using a digital camera of a mobile terminal of a mobile station subscriber, and automatically or manually transmitting coupon code data to a server according to a predetermined rule;
allowing the server to store the coupon code data in a personal database;
capturing the two-dimensional code pattern of the store code printed on the store medium using the digital camera of the mobile terminal of the mobile station subscriber, and automatically or manually transmitting store code data to the server according to a predetermined rule;
allowing the server to search the personal database and compare data in order to determine whether coupon data corresponding to the store code data exists;
allowing the server to transmit identification contents needed for using the coupon to the mobile terminal if corresponding coupon data exists;
allowing a store terminal to read the identification contents as a step of using the coupon; and
allowing the store terminal to record the used coupon and transmit coupon use data to the server.

9. The method according to claim 8, further comprising allowing the server to transmit coupon contents or advertisement contents corresponding to the coupon code to the mobile terminal.

10. The method according to claim 8, wherein the identification contents is a one-dimensional bar code image file.

11. The method according to claim 8, wherein the mobile terminal is a cellular phone embedded with the digital camera.

12. The method according to claim 8, wherein in the using of the coupon, the coupon is used in a method of discounting a price based on a predetermined percentage or in a method of exempting payment by total monetary value of points.

13. A mobile service method using a two-dimensional coupon code, comprising:
printing the coupon code on a coupon in the form of a two-dimensional code pattern;
capturing the two-dimensional code pattern of the coupon code printed on the coupon using a digital camera of a mobile terminal of a mobile station subscriber, and automatically or manually transmitting coupon code data to a server according to a predetermined rule;
allowing the server to store the coupon code data in a personal database; and
allowing the server to transmit coupon contents or advertisement contents corresponding to the coupon code to the mobile terminal.
